(19) United States
(12) Patent Application Publication
(10) Pub. No.: US 2007/0206379 A1
(43) Pub. Date: Sep. 6, 2007

(54) Illuminating lamp device

(76) Inventor: Chin-Hui Lin, Taipei County (TW)

Correspondence Address: CHIN-HUI LIN, 235 Chung - Ho, Box 8-24, Taipei, TW

(21) Appl. No.: 11/368,148

(22) Filed: Mar. 6, 2006

(51) Int. Cl. F21L 4/04

(52) U.S. Cl. 362/205

(57) ABSTRACT

An illuminating lamp device comprises a conductive casing having a transparent portion; a seat installed below the casing; a power source; a switch for actuating the power source and movably installed in the seat and passing through the seat to protrude out of a bottom of the casing; a conductive sheet extending from the switch; one end of the conductive sheet being connected to the power source; a lamp for emitting light; the lamp having two electrodes; one electrode being in contact with the casing; another electrode being placed above the conductive sheet; when the electrode being in contact with the conductive sheet, the circuit is conducted so that the lamp lights up. When the switch is pressed, the conductive sheet extending from the switch will contact the electrode so as to form an electric loop including the power source, conductive sheet, electrode, lamp and casing; and thus the lamp lights up.

### FIELD OF THE INVENTION

The present invention relates to lamps, and in particular to an illuminating lamp device, wherein the illuminating lamp device of the present invention is placed upon a surface, the weight of the lamp will make a switch to actuate a power source so that the lamp will light up. When the illuminating lamp device is lifted from the surface, the switch will de-actuate the power source so that the lamp distinguishes. Furthermore, at least one magnet is installed in the illuminating lamp device of the present invention. The magnet can absorb a tool so as to provide illumination function to the tool in operation.

### BACKGROUND OF THE INVENTION

In working, it is possible that the working area is dark and thus the operator cannot view of the tool so as to affect the operation. If a flashlight is used, the operator must take the flashlight by one hand. However this will induce inconvenience in operation, especially for the work necessary to be done by two hands. If the flashlight is hung, it is confined by the working place, especially for a complicated working place, for example a working place within the complicated machine. If the light is too strong, the operation will also be affected. Thus, the operator must take time to move the flashlight for adjusting the light to a suitable one. Thus the flashlight is needed to be moved again and again. One kind of screw opener has a light source in the handle, however the light source is too near the working place so that the light easily disperses or is hindered.

### SUMMARY OF THE INVENTION

Accordingly, the primary object of the present invention is to provide an illuminating lamp device, wherein the illuminating lamp device of the present invention is placed upon a surface, the weight of the lamp will make a switch to actuate a power source so that the lamp will light up. When the illuminating lamp device is lifted from the surface, the switch will de-actuate the power source so that the lamp distinguishes. Furthermore, at least one magnet is installed in the illuminating lamp device of the present invention. The magnet can absorb a tool so as to provide illumination function to the tool in operation.

To achieve above objects, the present invention provides an illuminating lamp device. The lamp comprises a conductive casing having a transparent portion; a seat installed below the casing; a power source; a switch for actuating the power source and movably installed in the seat and passing through the seat to protrude from a bottom of the casing; a conductive sheet extending from the switch; one end of the conductive sheet being connected to the power source; a lamp for emitting light; the lamp having two electrodes; one electrode being in contact with the casing; another electrode being placed above the conductive sheet; when the electrode being in contact with the conductive sheet, the circuit is conducted so that the lamp lights up. When the switch is pressed, the conductive sheet extending from the switch will contact the electrode so as to form an electric loop including the power source, conductive sheet, electrode, lamp and casing; and thus the lamp lights up.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

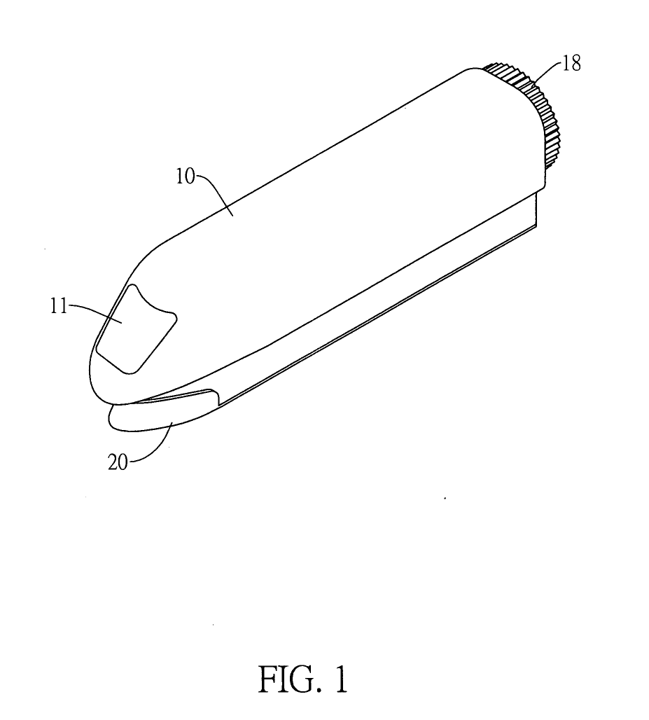

FIG. 2 is an exploded perspective view of the present invention.

FIG. 3 is a lateral cross sectional view of the present invention.

FIG. 4 is another lateral cross sectional view of the present invention.

FIG. 5 is a partial cross sectional view of the present invention.

FIG. 6 shows one application of the present invention.

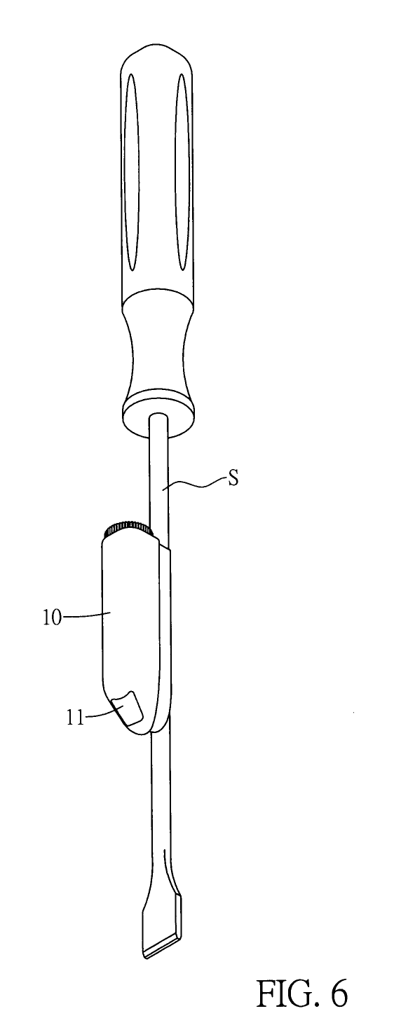

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

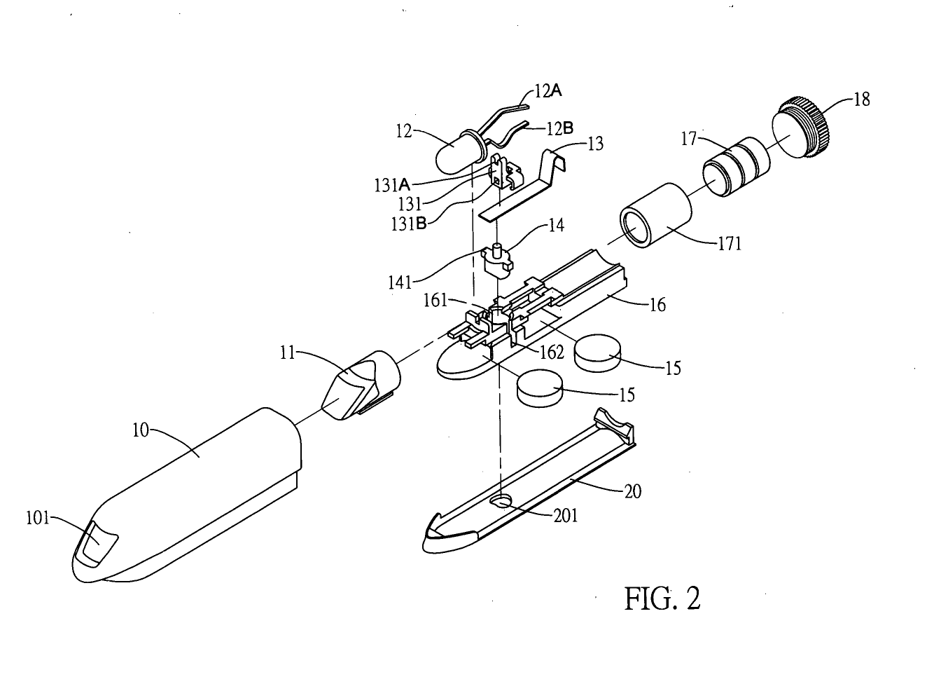

Referring to FIG. 2, the present invention has the following elements.

A conductive casing 10 has a transparent portion 101. A lampshade 11 is received in the transparent portion 101.

A seat 16 is installed below the casing 10. The seat 16 has a through hole and the through hole is formed with two grooves 162 at a wall of the through holes.

A switch 14 is movably installed in the seat 16 and passes through the seat 16 to protrude out from a bottom of the seat 16. Two sides of the switch 14 are installed with two blocks 141. The two blocks 141 are received into the two grooves 162 for retaining the switch 14 not to fall out from the seat 16.

Two magnets 15 are installed on two receiving spaces of the seat 16.

A power source (in this the present invention, it is a battery 17) is received in a battery base 171 and the battery base 171 is installed on a rear end of the seat 16. A conductive rear cover 18 is installed to one opening of the battery base 171 for retaining the battery 17 in the battery base 171. The casing 10, battery 17 and rear cover 18 are formed as a conductive loop. A front end of the battery 17 is installed with a conductive sheet 13. The conductive sheet 13 extends to an upper side of the switch 14. A middle section of the conductive sheet 13 is a press 131 so that the conductive sheet 13 is elastic.

An LED lamp 12 for emitting light is installed in the lampshade 11. Two electrode pins 12A, 12B are inserted into two slots 131A, 131B of the press 131 for preventing the contact of the two electrode pins. One electrode pin 12A is in contact with the casing 10. Another electrode pin 12B is placed above the conductive sheet 13. When the electrode pin 12B is in contact with the conductive sheet 13, the circuit is conducted so that the LED lamp 12 lights up. In the present invention, the LED lamp 12 and power source are called as a light emitting device. Furthermore, the LED lamp 12 can be replaced by a laser light, or lamps of other form.

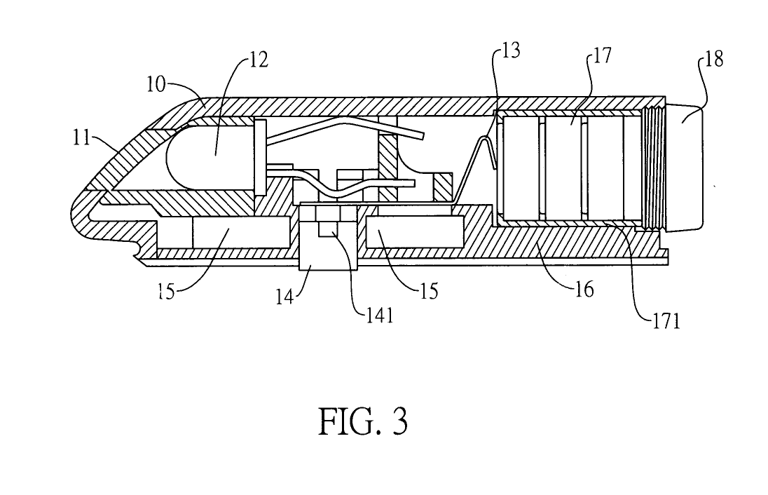

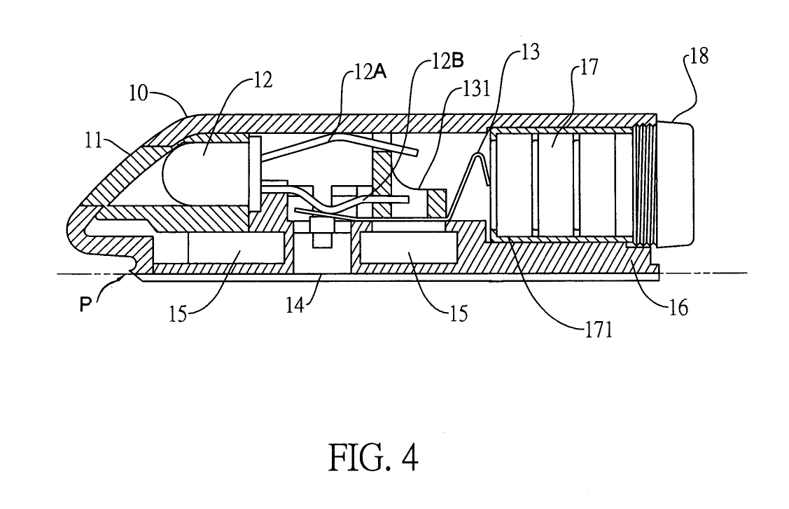

Referring to FIG. 3, an assembled cross sectional view of the present invention is illustrated. The switch 14 protrudes from the seat 16. The conductive sheet 13 is not in contact with the electrode pin 12B of the LED lamp 12. Referring to FIG. 4, the present invention is placed upon a plane P. Since the weight of the present invention presses downwards, the switch 14 pushes upwards to contact a pin 122 of the conductive sheet 13 to form a circuit loop. Then the LED lamp 12 lights up. If the lamp of the present invention leaves from the plane, by resilient force of the conductive sheet 13, the switch 14 is pushed. The electrode pin 12B separates from the conductive sheet 13. The LED lamp 12 will distinguish to return to the state illustrated in FIG. 3.

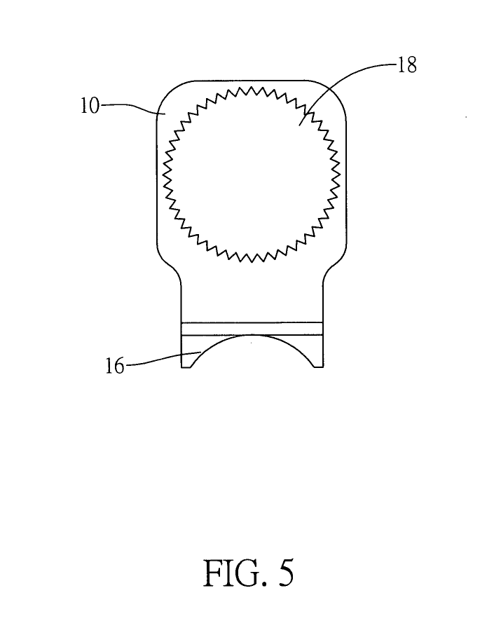

Referring to FIG. 5, the seat 16 is formed of a concave round surface. The magnets serve to attract to a screw opener S so that the switch 14 is pressed to make the conductive sheet 13 contacts the electrode pin 12B and thus the circuit is conducted. Thus, the screw opener can be operated in a light environment. However the magnet can be installed at other portion with other shapes. Furthermore, in storage for preventing the switch 14 is touched to light up the LED lamp 12, a lower cover 20 is installed. The lower cover 20 has a hole 201 to pass through the switch 14. Thereby the switch 14 will not be actuated. However the hole 201 can be formed as a recess for containing the switch 14 so that the switch 14 will not be actuated by mistake.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An illuminating lamp device comprising:
a conductive casing having a transparent portion;
a seat installed below the casing;
a power source;
a switch for actuating the power source and movably installed in the seat; the switch passing through the seat to protrude from a bottom of the casing; a conductive sheet extending from the switch; one end of the conductive sheet being connected to the power source;
a lamp for emitting light; the lamp having two electrodes; one electrode being in contact with the casing; another electrode being placed above the conductive sheet; when the electrode being in contact with the conductive sheet, the circuit is conducted so that the lamp lights up;
wherein the electrode above the conductive sheet; when the switch is pressed, the conductive sheet extending from the switch will contact the electrode so as to form an electric loop including the power source, conductive sheet, electrode, lamp and casing; and thus the lamp lights up.

2. The illuminating lamp device as claimed in claim 1, wherein at least one magnet is installed on receiving spaces of the seat.

3. The illuminating lamp device as claimed in claim 1, wherein the seat has a cambered round shape.

4. The illuminating lamp device as claimed in claim 1, with the lamp is one of an LED lamp and a laser lamp.

5. The illuminating lamp device as claimed in claim 1, wherein a lampshade received in the transparent portion; and the lamp is received the lampshade.

6. The illuminating lamp device as claimed in claim 1, wherein the power source is a battery.

7. The illuminating lamp device as claimed in claim 6, wherein the power source is received in a battery base and the power source is installed on a rear end of the seat.

8. The illuminating lamp device as claimed in claim 1, wherein a conductive rear cover is installed to one opening of the battery base for retaining the power source in the battery base.

9. The illuminating lamp device as claimed in claim 7, wherein a conductive rear cover is installed to one opening of the battery base for retaining the power source in the battery base.

10. The illuminating lamp device as claimed in claim 1, wherein a lower cover is installed.

11. The illuminating lamp device as claimed in claim 10, wherein the lower cover has a hole to pass through the switch; and thereby the switch will not be actuated.

12. The illuminating lamp device as claimed in claim 8, wherein the electrode contacting with the casing makes currents can flow through the rear cover to transfer to another electrode.

13. The illuminating lamp device as claimed in claim 1, wherein a middle section of the conductive sheet has a press so that the conductive sheet is elastic.

14. The illuminating lamp device as claimed in claim 13, wherein the press has two slots for receiving the two electrodes of the lamp so that the two electrodes will not contact with one another.
